(19) United States
(12) Patent Application Publication
(10) Pub. No.: US 2005/0230650 A1
(43) Pub. Date: Oct. 20, 2005

(54) Irrigation valve assembly

(75) Inventor: Gerald E. Peterson, Riverside, CA (US)

Correspondence Address: MANATT PHELPS AND PHILLIPS;ROBERT D. BECKER, 1001 PAGE MILL ROAD, BUILDING 2, PALO ALTO, CA, 94304, US

(73) Assignee: RAIN BIRD CORPORATION, GLENDORA, CA (US)

(21) Appl. No.: 10/824,717

(22) Filed: Apr. 14, 2004

(51) Int. Cl. F16K 51/00

(52) U.S. Cl. 251/148

(57) ABSTRACT

The irrigation valve assembly includes a control valve with outwardly directing inlet and outlet ports, a connector sub-assembly forming an integral part of each of the ports. The connector sub-assembly includes a swivel connector positioned on the ends each of the ports for freely rotating around an axis control valve and for connecting and removing pipe sections without having to rotate the entire valve assembly and maintaining the spacing of each lateral section of pipe. A sealing ring is provided on the ends of the ports between the ends of the pipe sections that provide a seal between the pipe and the valve assembly when the swivel connector is fully engaged onto the threaded end of the pipe section. The swivel connector has a female threaded end capable of receiving a male threaded end of a section of irrigation pipe and an unthreaded end having a shoulder having a thickness capable of being forced over a corresponding shoulder on the ends of the ports.

### FIELD OF THE INVENTION

The present invention relates to a valve assembly that is easily connected to and disconnected from lateral sections of irrigation pipe connected to a water supply.

### BACKGROUND OF THE INVENTION

Irrigation systems require valves to be connected to and disconnected from lateral sections of irrigation pipes that are in turn connected to a supply of water. Prior art irrigation valves are connected by threading them onto pipe sections using a sealant such as Teflon tape to prevent leakage. The pipe sections and valves are typically plastic such as polyvinyl chloride (PVC). However, because of the nature of the plastic materials used to manufacture the irrigation pipe sections and valves and the environmental conditions of temperature and pressure, the joints between the valves and the sections leak even when they are thoroughly tightened.

It is well known in the prior art to provide union fittings for the valves to create male threaded extensions. The union fitting in the prior art typically has one of the male threaded ends for being screwed into each of the threaded openings of the valve. The other male threaded end is capable of being screwed into a nut positioned behind a flange attached to a section of pipe to be connected. The problem with such union fittings is that they suffer from the same disadvantage as conventional connections of the male fittings on the inlet and outlet ports of the valve. In such prior art fittings, the entire valve must still be rotated to unthread the valve and remove it from the union fittings.

Irrigation systems require a network of pipe sections to be connected to valves that lay on the ground in close proximity to one another on a manifold. Because the prior art valves having internally (female) threaded openings are threaded onto the male threaded ends of the pipe sections as discussed in the above paragraph, sufficient clearance must be provided to allow rotation of the valve around its axis during threading and unthreading of the valve. Often in such prior art systems, the lateral spacing between the valves and the pipe sections must be increased to provide sufficient clearance. Another problem with the prior art irrigation systems is the failure to provide an adequate seal between the valve and pipe sections.

There is a need for an irrigation valve assembly that can be easily connected and disconnected while maintaining the same spacing between the lateral sections that are being connected to the inlet and outlet ports of the valve assembly and one that does not require having to move the sections. There is also a need for an assembly that does not require the rotation of the entire assembly onto the male threads of the pipe. There is also a need for a valve assembly that prevents leaks between the valve ports and the threaded connections.

### BRIEF DESCRIPTION OF THE DRAWINGS

The foregoing aspects and the attendant advantages of the present invention will become more readily appreciated by reference to the following detailed description, when taken in conjunction with the accompanying drawings, wherein:

FIG. 1A is a perspective view of a preferred embodiment of the irrigation valve assembly of the present invention being placed into position between inlet and outlet pipe sections;

FIG. 1B is a perspective view of the irrigation valve assembly after the swivel connectors have been threaded into inlet and outlet pipe sections;

FIG. 2 is a perspective view of the irrigation valve assembly showing a cross-sectional view of the inlet and outlet ports of the control valve, the connector sub-assembly, and the sealing ring of the irrigation valve assembly and; and

FIG. 3 is a cross-sectional vertical view of an outlet port of the control valve connected to a section of irrigation pipe, including the swivel connector and the sealing ring of the irrigation valve assembly of the present invention.

### DETAILED DESCRIPTION OF PREFERRED EMBODIMENTS OF THE INVENTION

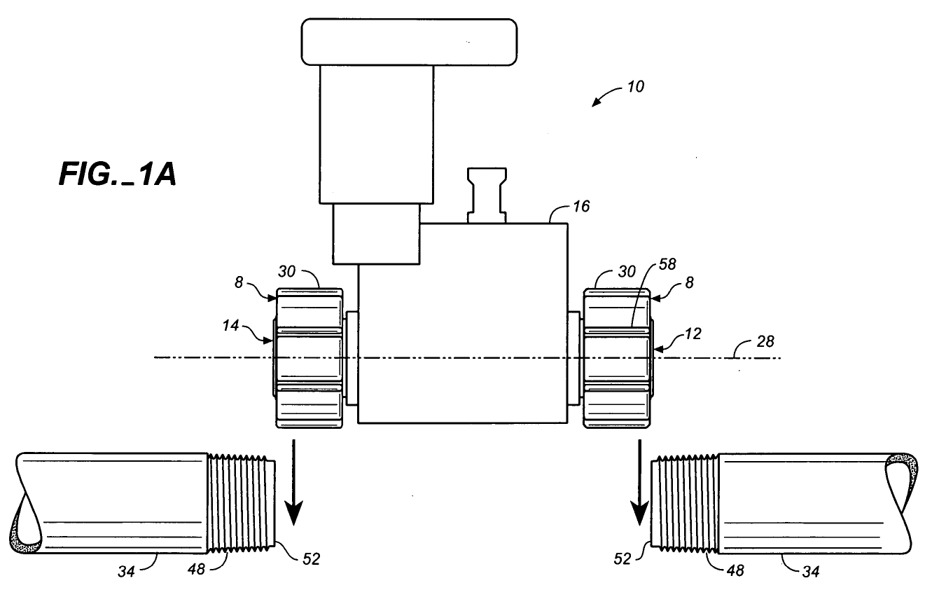

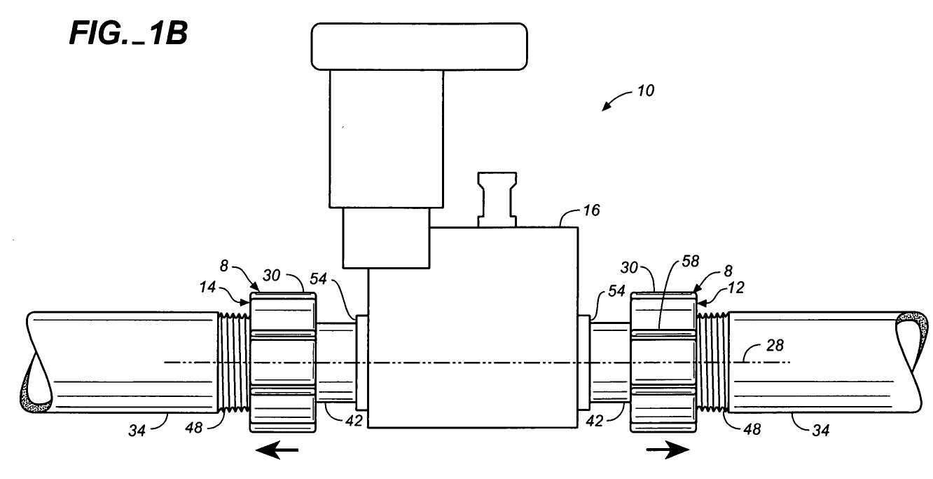

Referring now to FIGS. 1A, 1B, 2 and 3, a preferred embodiment of an irrigation valve assembly is shown, including connector sub-assembly 8 which forms an integral part of control valve 10. Control valve 10 has inlet port 12 and outlet port 14 that extend outwardly from valve body 16 and outwardly facing end 17 containing annular groove 18 capable of receiving sealing ring 20, preferably in the form of an O-ring. Shoulder 26 of control valve 10 is adjacent to each annular groove 18 and has an inwardly directing end 27 that is substantially perpendicular to axis 28 of control valve 10. The corresponding outwardly directing end of shoulder 26 that is opposite inwardly directing end 27 is the outer corner of end 17 of each of ports 12 and 14.

Connector sub-assembly 8 includes a pair of swivel connectors 30 capable of freely rotating around longitudinal axis 28. Preferably swivel connector 30 is a plastic threaded fitting, which has female threaded end 32 for connecting to the male threaded ends of sections 34 of an irrigation pipe. Unthreaded end 36 of connector 30 has shoulder 38, which has outwardly directing end 39 that is substantially perpendicular to axis 28 of control valve 10. The corresponding inwardly directing end of shoulder 38 is the inner corner of unthreaded end 36. Inner surface 40 of shoulder 38 extends between unthreaded end 36 and outwardly directing end 39 and is adjacent to outer surface 42 of each of ports 12 and 14.

Sufficient clearance 44 is maintained between inner surface 40 and outer surface 42 to allow connectors 30 to freely rotate about axis 28 and to allow freedom for lateral movement along axis 28 before the male threads 48 of pipe sections 34 engage the female threads 50 of connectors 30. Sufficient clearance must also be allowed between male threads 48 and threads 50 to assure easy engagement of pipe section 34 even if there are variations in the size of the mating pipe threads. Connector 30 must be able to be screwed all the way onto the pipe threads 48 without licking on the taper of the mating threads.

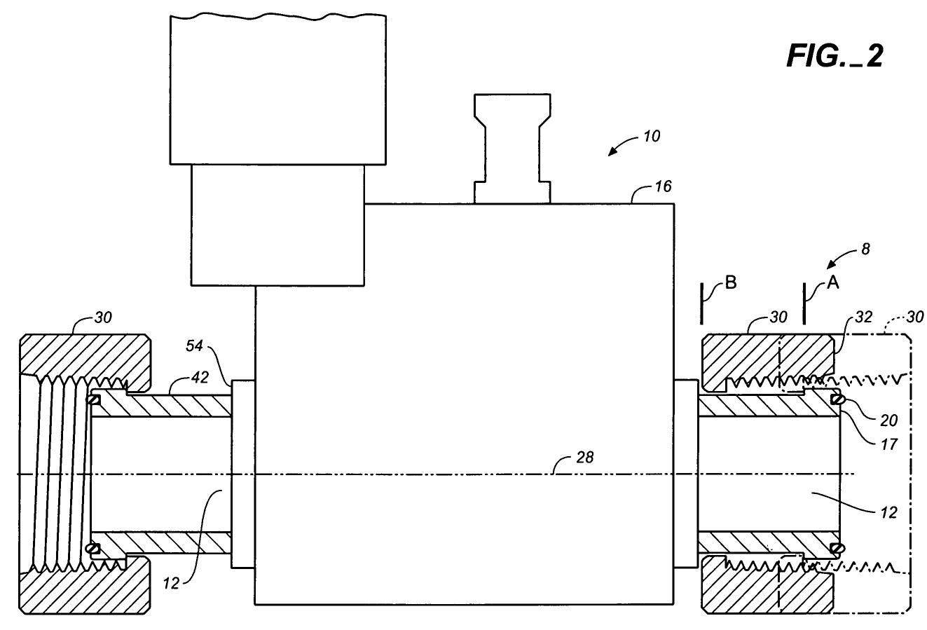

FIG. 2 shows connector 30 on the right side of control valve 10 after moving from connector position A to connector position B in which connector 30 is positioned for receiving pipe section 34. Connector 30 is designed to freely move inwardly along inner surface 42 so that end 36 is adjacent end 54 of valve body 16 in position B.

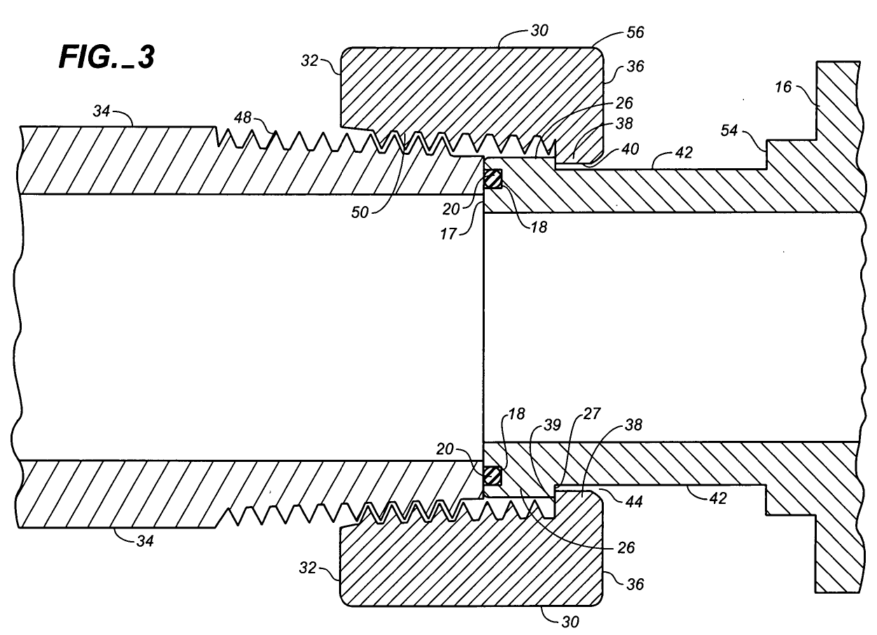

FIG. 3 shows connector position A in which connector 30 is tightened onto threads 48 of pipe section 34 so that end 52 of section 34 is fully engaged against O-ring 20. In position A, outwardly directing end 39 of shoulder 38 abuts inwardly directing end 27 of shoulder 26.

FIGS. 1A and 1B show one of the advantages of the irrigation valve assembly of the present invention. Pipe sections 34 remain in a fixed position along the surface of the ground. If control valve 10 must be replaced, connectors 30 on inlet 12 and 14 are completely unthreaded and are moved to position B. In FIG. 1A, connectors 30 are in connector position B after being urged inwardly so that ends 36 either are adjacent or abut ends 54 of valve body 16. Control valve 10 can easily be placed into position between ends 52 of two sections 34 without any appreciable lateral movement of sections 14. In the position B, threaded ends 32 of connectors 30 are preferably designed to be in vertical alignment with the inner wall of groove 18 for O-ring 20 to allow clearance between ends 52 of sections 36 to enable control valve 10 to be easily fitted into place. After replacement control valve 10 has been fitted into place, ends 52 on each of sections 34 are flush against ends 17 of control valve 10. O-ring 20 is slightly compressed against the inner wall of groove 18 to provide an effective seal between ends 52 and ends 17 after connectors 30 have been tightened onto pipe threads 48. Ribs 58 on the outer walls of connectors 38 are designed to allow the connectors to be easily tightened by hand. While connectors 30 are being tightened, valve body 16 remains in a fixed position relative to pipe sections 34. FIG. 1B shows connector position A after connectors 30 have been tightened onto threads 48.

Control valve 10 can also be easily removed from sections 34 without appreciable lateral movement of the sections by loosening connectors 30 and sliding them inwardly until ends 36 are adjacent ends 54.

The height of shoulder 26 is the distance inwardly directing end 27 is from outer surface 42 of ports 12 and 14. The thickness of shoulder 38 is the distance outwardly directing end 39 of shoulder 38 extends above threads 50. On the one hand, these distances should be large enough to prevent connector 30 from being removed from control valve 10 during the rigorous field operations. On the other hand, these distances should be small enough to enable the shoulder 38 on connector 30 to be forced over shoulder 26 of ports 12 and 14. Once connectors 30 are in place they must permanently attached to valve assembly 10. The height of shoulder 26 and thickness of shoulder 38 are substantial equal and range from about 1/16 to ⅓ the thickness of inwardly directing end 36, which is the distance from inner surface 40 to outer surface 56 of connector 30.

In a specific example of a PVC valve assembly 10, connector 30 had a thickness of end 36 of 0.4 inch for threading fully onto any standard 1 inch male NPT (National Pipe Taper) or BSP (British Standard Pipe) fitting. Connector 30 was permanently attached to the valve inlet port 12 and outlet port 14 by compressing shoulder 38 of connector 30 over a tapered metal mandrel to a fraction of the thickness of outwardly directing end 39. Shoulder 38 was compressed within the range of about 0.04 to about 0.08 inch. Immediately after being compressed, connector 30 was removed from the tapered mandrel and was easily forced over shoulder 26. Shoulder 38 was then allowed sufficient time to resume substantially its original shape based on well known principles of plastic hysteresis.

Various modifications of the control valve assembly of the present invention in addition to those shown and described above will become apparent to those skilled in the art from the foregoing description and accompanying drawings. Such modifications are intended to fall within the scope of the appended claims.

1. An irrigation valve assembly for connecting to lateral sections of irrigation pipes comprising:
a control valve having an inlet port and an outlet port, said ports each having an annular groove in one end thereof;
a connector sub-assembly having a pair of threaded swivel connectors forming an integral part of said inlet port and said outlet port, each swivel connector having a threaded end connectable to a male pipe fitting on the lateral section for allowing said connector sub-assembly to rotate about an axis of said control valve and for allowing the removal of said valve assembly while maintaining the spacing of each of the lateral sections of the irrigation pipe; and
a sealing ring mounted in each of said annular grooves on the ends of said inlet and outlet ports and alignable with the male pipe fitting for providing a seal between said male pipe fitting and the ends of the ports when the threaded end of said swivel connector is connected to said male pipe fitting of the irrigation pipe section.

2. The assembly of claim 1, wherein each of said ports has a shoulder at its outwardly directing end and each of said swivel connectors has an unthreaded end having a shoulder capable of being forced over the corresponding shoulder on each end of the ports.

3. The assembly of claim 2, wherein the threaded ends of said swivel connectors are adjacent the respective ends of the inlet and outlet ports after the treaded ends of said connectors are unthreaded from the pipe fittings prior to removal of said valve assembly.

4. The assembly of claim 3, wherein the swivel connectors move from a first connector position on the respective inlet and outlet ports in which the threaded ends of said swivel connectors are adjacent the respective ends of the inlet and outlet ports to a second connector position in which the threaded ends of said swivel connectors are connected to the male pipe fittings.

5. The assembly of claim 4, wherein the shoulder at the unthreaded end of each of the swivel connectors has an outwardly directing end juxtaposed to an inwardly directing end of the corresponding shoulder on the end of the port.

6. The assembly of claim 5, wherein each of the outwardly directing ends of the swivel connectors abut each of the respective inwardly directing ends when the female threaded ends of said swivel connectors are connected to the male pipe fittings.

7. The assembly of claim 6, wherein sufficient clearance exists between outer surfaces of each of the inlet and outlet ports and inner surfaces of each of the shoulders on the unthreaded ends of the swivel connectors to allow the connectors to freely rotate about the axis of the valve and to allow freedom for lateral movement along the axis before threaded ends of said swivel connectors are connected to the male pipe fittings.

8. The assembly of claim 7, wherein the thickness of the shoulder of each of the swivel connectors and the height of the shoulder of each of the ports are sized to allow one shoulder of being forced over other shoulder and to prevent the connectors from being removed from the control valve.

9. The assembly of claim 8, wherein the shoulder of each of the swivel connectors is forced over the corresponding shoulder of each of the port by compressing the thickness of the swivel connector shoulder, forcing the swivel shoulder over the corresponding shoulder on the ports, and allowing time for the shoulder to resume substantially is original shape.

10. An irrigation valve assembly for connecting to lateral sections of irrigation pipes comprising:
a control valve having an inlet port and an outlet port, said ports each having an annular groove in one end thereof and a shoulder in the other end thereof;
a connector sub-assembly having a pair of threaded swivel connectors forming an integral part of said inlet port and said outlet port, each swivel connector has a female threaded end capable of receiving a male threaded end of a male pipe fitting on the lateral section and an unthreaded end having a shoulder capable of being forced over the corresponding shoulder on each of the other ends of the ports; sufficient clearance being provided between outer surfaces of each of the inlet and outlet ports and inner surfaces of each of the shoulders on the unthreaded ends of the swivel connectors to allow the connectors to freely rotate about a longitudinal axis of the valve and to allow freedom for lateral movement along the axis before the threaded ends of said swivel connectors are connected to the male pipe fittings; said swivel connectors being able to move from a first connector position on the respective inlet and outlet ports in which the threaded ends of said swivel connectors are adjacent the respective ends of the inlet and outlet ports for allowing the removal of said valve assembly while maintaining the spacing of each of the lateral sections of the irrigation pipe to a second connector position in which the threaded ends of said swivel connectors are connected to the male pipe fittings;
a sealing ring mounted in each of said annular grooves on the ends of said inlet and outlet ports and alignable with the male pipe fitting for providing a seal between said male pipe fitting and the ends when the female threaded end of said swivel connector is connected to said male pipe fitting of the irrigation pipe section.

11. The assembly of claim 10, wherein the thickness of the shoulder of each of the swivel connectors and the height of the shoulder of each of the ports are sized to allow one shoulder of being forced over other shoulder and to prevent the connectors from being removed from the control valve.

12. The assembly of claim 11, wherein the shoulder of each of the swivel connectors is forced over the corresponding shoulder of each of the port by compressing the thickness of the swivel connector shoulder, forcing the swivel shoulder over the corresponding shoulder on the ports, and allowing time for the shoulder to resume substantially is original shape.
